(19) United States
(12) Patent Application Publication
(10) Pub. No.: US 2016/0275400 A1
(43) Pub. Date: Sep. 22, 2016

(54) Device Charging Discovery Service

(71) Applicant: Microsoft Technology Licensing, LLC, Redmond, WA (US)

(72) Inventors: Stephen E. Hodges, Cambridge (GB); Ranveer Chandra, Bellevue, WA (US); Julia L. Meinershagen, Seattle, WA (US); James William Scott, Cambridge (GB)

(21) Appl. No.: 14/662,938

(22) Filed: Mar. 19, 2015

(51) Int. Cl. G06N 5/04; H02J 7/00

(52) U.S. Cl. CPC G06N 5/04; H02J 7/0047; H02J 7/0052

(57) ABSTRACT

Device charging discovery service techniques are described in which a service collects data regarding charging station availability (e.g., locations where device batteries can be charged) through interaction with a community of devices. Devices provide feedback to the service when charging stations are encountered. The service maintains a database of charging stations that is based upon the community feedback. The database is then used to respond to requests for charging station availability. For instance, the service forms individualized recommendations according to the device location, charge level, behavior data, and other device conditions. The service then communicates recommendations to enable output of the recommendations at corresponding devices. Recommendations can provide information regarding charging station locations as well as the type of power source, charging capabilities, costs to charge, and other factors. Based on the recommendations, users are able to make intelligent and informed decisions regarding when and where to recharge their devices.

### BACKGROUND

Mobile computing devices have been developed to increase the functionality that is made available to users in a mobile setting. For example, a user may interact with a mobile phone, tablet computer, or other mobile computing device to check email, surf the web, compose texts, interact with applications, and so on. One challenge that faces developers of mobile computing devices is efficient power management and extension of battery life. For example, extended processing of tasks by processors at or near capacity may drain the device battery and create thermal conditions that may force shutdown of the device. Various power management strategies may be applied to control processor and battery utilization generally at the expense of overall device performance. If power management implemented for a device fails to strike a good balance between performance and battery life, user dissatisfaction with the device and manufacturer may result. Power management traditionally focuses on power conservation and extension of battery life from a device and battery usage perspective. However, little consideration has been given to development of power management schemes that account for charging opportunities and provide users with indications regarding when and where they may be able to charge their devices.

### SUMMARY

Device charging discovery service techniques are described herein. In one or more implementations, a service is implemented to collect data regarding availability of device charging stations (e.g., locations where device batteries can be charged) through interaction with a community of devices. For example, devices may provide feedback to the service when charging stations are used or encountered by the devices. The service is configured to maintain a database of charging stations based at least in part upon the community feedback. The database of charging stations is then used to respond to requests for charging station availability. For example, recommendations may be formed that are individualized according to the device location, charge level, behavior data, and other device conditions specified in requests. The service then communicates recommendations that are effective to cause output of notifications regarding the recommendations at corresponding devices. Recommendations may be configured to provide information regarding charging station locations as well as detailed information regarding the type of power, charging capabilities, costs to charge, and other factors. Based on the recommendations, users are able to make intelligent and informed decisions regarding when and where to recharge their devices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment in accordance with one or more implementations.

FIG. 2 is diagram depicting a system that represents example details of a charging discovery service in accordance with one or more implementations.

FIG. 3 is a flow diagram that describes details of an example procedure to provide individualized recommendations to devices regarding charging opportunities in accordance with one or more implementations.

FIG. 4 is a flow diagram that describes details of an example procedure for communication of charging recommendations that account for future charging opportunities to devices in accordance with one or more implementations.

FIG. 5 is a flow diagram that describes details of an example procedure to perform operations for discovery of opportunities for charging in accordance with one or more implementations.

FIG. 6 is a block diagram of a system that can be employed for aspects of device charging discovery techniques in accordance with one or more implementations.

### DETAILED DESCRIPTION

### Overview

Traditionally, power management for devices focuses on power conservation and extension of battery life from a device and battery usage perspective. However, little consideration is given to development of power management schemes that account for charging opportunities and provide users with indications regarding when and where they may be able to charge their devices.

Device charging discovery service techniques are described herein. In one or more implementations, a service is implemented to collect data regarding availability of device charging stations (e.g., locations where device batteries can be charged) through interaction with a community of devices. For example, devices may provide feedback to the service when charging stations are used or encountered by the devices. The service is configured to maintain a database of charging stations based at least in part upon the community feedback. The database of charging stations is then used to respond to requests for charging station availability. For example, recommendations may be formed that are individualized according to the device location, charge level, behavior data, and other device conditions specified in requests. In some cases, recommendations may also be based in part upon predictions regarding future locations and usage of devices that can be derived based on analysis of users behaviors and travel patterns. The service communicates recommendations that are effective to cause output of notifications regarding the recommendations at corresponding devices.

Recommendations may be configured to provide information regarding charging station locations as well as detailed information regarding the type of power, charging capabilities, costs to charge, and other factors.

Device charging discovery service techniques described herein enable users to make intelligent and informed decisions regarding when and where to recharge their devices. Rather than curating a database of charge locations independently, the charging discovery service leverages feedback from a community of users/devices to collect information regarding potential charging stations and details regarding the stations. By leveraging information from the community at large, the time, resources, and cost associated with providing the charging discovery service can be reduced. Additionally, recommendations may incorporate ratings and comments from individuals who use the charging station, as well as the basic details of the charging stations, which enables users to base charging decisions on a diverse set of criteria. Further, by considering and taking advantage of charging opportunities using recommendations from the service, users may tailor charging to different situations and utilize their devices more efficiently, which may lead to increased device performance and extended battery life.

In the discussion that follows, a section titled “Operating Environment” is provided and describes one example environment in which one or more implementations can be employed. Following this, a section titled “Charging Discovery Service Implementation Details” describes example details and procedures in accordance with one or more implementations. Last, a section titled “Example System” describes example computing systems, components, and devices that can be utilized for one or more implementations.

Operating Environment

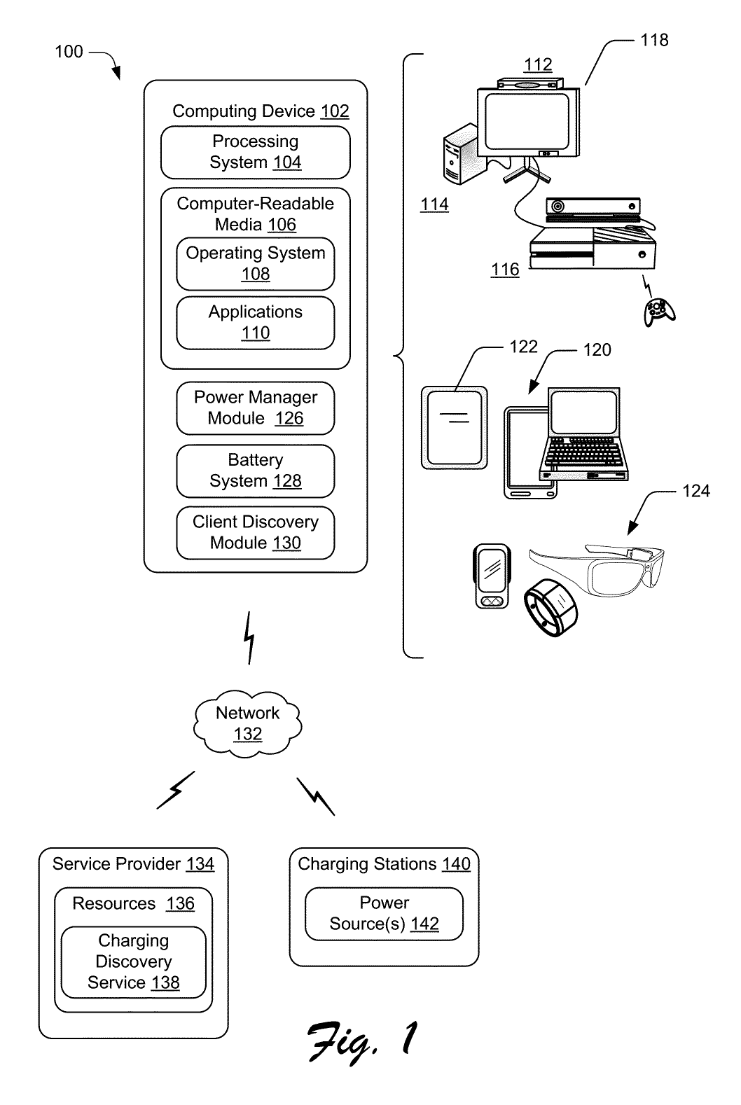

FIG. 1 illustrates an operating environment in accordance with one or more embodiments, generally at 100. The environment 100 includes a computing device 102 having a processing system 104 with one or more processors and devices (e.g., CPUs, GPUs, microcontrollers, hardware elements, fixed logic devices, etc.), one or more computer-readable media 106, an operating system 108, and one or more applications 110 that reside on the computer-readable media and which are executable by the processing system. The processing system 104 may be configured to include multiple independent processors configured in parallel or in series and one or more multi-core processing units. A multi-core processing unit may have two or more processors (“cores”) included on the same chip or integrated circuit. In one or more implementations, the processing system 104 may include multiple processing cores that provide a range of performance capabilities, processing efficiencies, and power usage characteristics.

The processing system 104 may retrieve and execute computer-program instructions from applications 110 to provide a wide range of functionality to the computing device 102, including but not limited to gaming, office productivity, email, media management, printing, networking, web-browsing, and so forth. A variety of data and program files related to the applications 110 can also be included, examples of which include games files, office documents, multimedia files, emails, data files, web pages, user profile and/or preference data, and so forth.

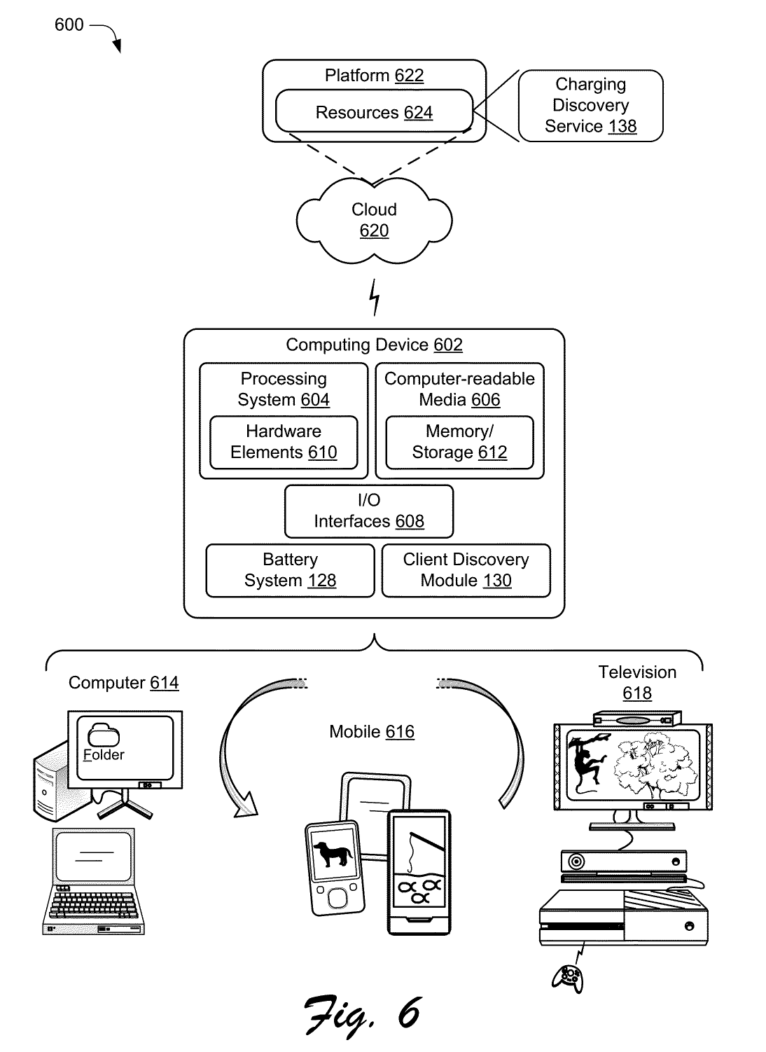

The computing device 102 can be embodied as any suitable computing system and/or device such as, by way of example and not limitation, a gaming system, a desktop computer, a portable computer, a tablet or slate computer, a handheld computer such as a personal digital assistant (PDA), a cell phone, a set-top box, a wearable device (e.g., watch, band, glasses, etc.), and the like. For example, as shown in FIG. 1 the computing device 102 can be implemented as a television client device 112, a computer 114, and/or a gaming system 116 that is connected to a display device 118 to display media content. Alternatively, the computing device may be any type of portable computer, mobile phone, or portable device 120 that includes an integrated display 122. A computing device may also be configured as a wearable device 124 that is designed to be worn by, attached to, carried by, or otherwise transported by a user. Examples of wearable devices 124 depicted in FIG. 1 include glasses, a smart band or watch, and a pod device such as clip-on fitness device, media player, or tracker. Other examples of wearable devices 124 include but are not limited to badges, a key fob, an access card, and a ring, an article of clothing, a glove, or a bracelet, to name a few examples. Further the computing device 102 may represent an on-board computer of a vehicle, such as an electric car, motorbike, boat, utility vehicle, or other vehicle that has a chargeable battery system. Any of the computing devices can be implemented with various components, such as one or more processors and memory devices, as well as with any combination of differing components. One example of a computing system that can represent various systems and/or devices including the computing device 102 is shown and described below in relation to FIG. 6.

The computer-readable media can include, by way of example and not limitation, all forms of volatile and non-volatile memory and/or storage media that are typically associated with a computing device. Such media can include ROM, RAM, flash memory, hard disk, removable media and the like. Computer-readable media can include both “computer-readable storage media” and “communication media,” examples of which can be found in the discussion of the example computing system of FIG. 6.

The computing device 102 may also include a power manager module 126 and a battery system 128 that operate as described above and below. The power manager module 126 and battery system 128 may be provided using any suitable combination of hardware, software, firmware, and/or logic devices. As illustrated, the power manager module 126 and battery system 128 may be configured as separate, standalone modules. In addition or alternatively, the power manager module 126 may also be configured as a module that is combined with the operating system 108 or implemented via a controller or other component of the battery system 128.

The battery system 128 is configured to include one or more battery cells that may be configured in various ways. For instance, battery cells can include includes cells having different characteristics such as different sizes/capacities, chemistries, battery technologies, shapes, state of charge (SOC), charge rates, discharge rates and so forth. Accordingly, the battery system 128 may include a diverse combination of multiple battery cells at least some of which have different characteristics one to another. Various combinations of one or more battery cells and one or more types of battery cells may be utilized to provide a range of capacities, performance capabilities, efficiencies, and power usage characteristics. In one or more implementations, charging techniques discussed above and below can also be extended to cover accessory devices associated with a computing device that have chargeable batteries, such as a wearable device, wireless headphones, input device or keyboard, and so forth. The techniques may also apply to external “mobile” battery devices, extra batteries, and accessory device batteries that users may carry along with them and utilize as a source of supplemental power for a different device. Such batteries include batteries that are swapped in for other batteries in a device (e.g., a spare laptop battery) and “extension” batteries that can be used to power and/or recharge one or more devices, consecutively or simultaneously (e.g., a battery case for a phone, a USB battery pack, accessory device with capabilities to share power, etc.). Different devices can also share power between themselves if power transfer is supported by the device and the correct ports, cables, and interfaces to accomplish the transfer are available. For example, power may be exchanged from a user's laptop to a mobile phone, between two mobile phones, and so forth. Thus, charging recommendations can be made for a collection of multiple related devices of a user in consideration of the battery systems and charge states of each of the multiple related devices.

The power manager module 126 represents functionality operable to assess system-wide power management considerations and manage the availability cells of the battery system 128, processors, and/or processing cores based on the assessment. In one or more implementations, the power manager module 126 may be configured to implement charging policies established based on power management considerations to control the battery system 128. This may involve analyzing contextual factors including but not limited to usage preferences or requests from users or applications, battery characteristics, battery charge levels/states, device power state, actual and anticipated workloads, power source characteristics, time available for charging, thermal conditions, user presence, processor/core utilization, application context, device context, priority, and other contextual clues that may be used to drive power management decisions at the system level. The power manager module 126 may be configured to apply different charging policies that are mapped to different combinations of the contextual factors such that charging is dynamically tailored to different contexts in which charging occurs. Applying a charging policy may involve communicating control signals or directives to direct operation of a charge controller and/or other hardware of the battery system 128 to implement a particular charging policy that is selected based on analysis of the contextual factors.

Additionally, the computing device includes a client discovery module 130. Generally, the client discovery module 130 represents functionality operable via a computing device to obtain and utilize information regarding the availability of charging stations that may be used to charge the device in various ways. For example, the client discovery module 130 may interact with a service (e.g., a charging discovery service as discussed below) to get recommendations that indicate locations of nearby charging stations and related details. As described herein, recommendations may be based on feedback regarding device conditions that can be supplied by the client discovery module 130 to the service. The feedback may include but is not limited to information regarding device/user behaviors, preferences, load conditions, historic activity and travel patterns, and predictions for future locations, usage, loads, travel routes, and so forth. In addition or alternatively, client discovery module 130 may operate to form recommendations on the client-side based on information regarding charging stations supplied from the service and device conditions monitored at the device.

The client discovery module 130 may be implemented as a component of the power manger module 126 or as a standalone module as illustrated. In one or more implementations, the client discovery module 130 operates under the influence of the power manager module 126 according to directives that are sent by the power manager module 126 to control operation of the client discovery module 130 and communicate data back and forth. In this way, actions of the client discovery module 130 are coordinated with an overall power management scheme and policies enforced by the power manager module 126.

The environment 100 further depicts that the computing device 102 may be communicatively coupled via a network 132 to a service provider 134, which enables the computing device 102 to access and interact with various resources 136 made available by the service provider 134. The resources 136 can include any suitable combination of content and/or services typically made available over a network by one or more service providers. For instance, content can include various combinations of text, video, ads, audio, multi-media streams, applications, animations, images, webpages, and the like. Some examples of services include, but are not limited to, an online computing service (e.g., “cloud” computing), an authentication service, web-based applications, a file storage and collaboration service, a search service, messaging services such as email and/or instant messaging, and a social networking service.

One example of a resource 136 is a charging discovery service 138 as represented in FIG. 1. The charging discovery service 138 is representative of a service made accessible to client devices that facilitates access to information regarding availability of charging stations 140 for the devices. As represented in FIG. 1, charging stations 140 are configured to provide power sources 142 that may be employed to charge battery cells of users' devices. Various different power sources 142 are contemplated, and different types of charging stations 140 and power sources 142 may be suitable for different devices (e.g., a vehicle charging stations, mobile device charging stations, wall outlets, pay stations, multi-purpose stations etc.). Charging stations 140 may also have different capabilities in terms of charge rates, types of devices supported, hardware and adapters available, types of adapters or plugs required to charge, and so forth. The charging stations 140 correspond to geographic locations, entities, businesses, buildings, infrastructure, people, and places at which power sources 142 are made available for device charging.

Accordingly, the client devices may access and interact with functionality exposed via the charging discovery service 138 via a client discovery module 130 or comparable application to obtain information regarding charging stations 140. The charging discovery service 138 may maintain a database having information regarding locations for the charging stations and other details, such as energy source type (fossil fuel or other fuel type), identification of clean or green sources (wind, solar, hydro, etc.), status as public or private, identification as a pay or free station, ratings and recommendations, indications of other amenities, owner/operator, hours of operations, and other relevant details. As noted above and below, the charging discovery service 138 produces the database based at least in part upon feedback from client devices. In other words, the database includes “crowd-sourced” data that is supplied from a community of users rather than relying upon information that is curated entirely by the service. In this way, the cost and complexity of maintaining the database is reduced substantially. Additionally, the charging discovery service 138 utilizes information regarding device conditions supplied by devices to form recommendations for charging station availability and to individualize the recommendations based on various factors. Additional details regarding implementation and operation of a charging discovery service 138 are described in the following section.

Having discussed an example operating environment, consider now example details and techniques associated with one or more implementations of a charging discovery service.

Charging Discovery Service Implementation Details

To further illustrate, consider the discussion in this section of example devices, components, procedures, and implementation details that may be utilized to provide aspects of charging discovery service techniques as described herein. In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

Example Charging Discovery Service

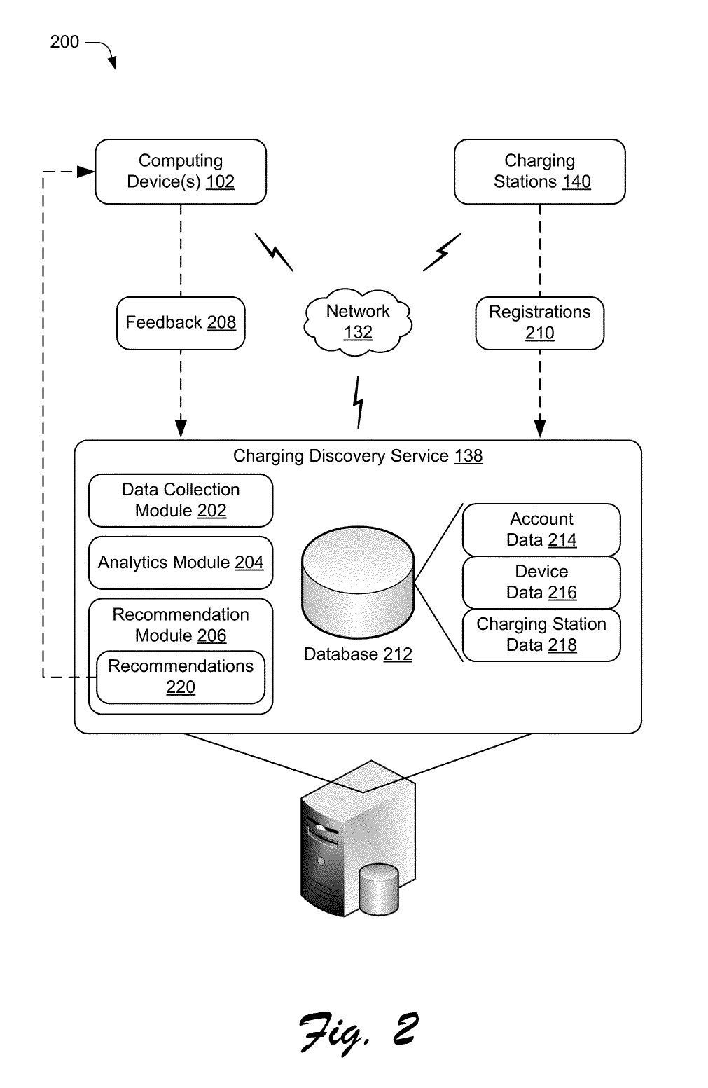

FIG. 2 depicts generally at 200 a system that represents example details of a charging discovery service in accordance with one or more implementations. By way of example and not limitation, a charging discovery service 138 may be implemented by one or more server devices associated with a service provider 134. In order to provide functionality related to discovery of charging stations 140, the charging discovery service 138 includes or makes use of a data collection module 202, an analytics module 204, and a recommendation module 206. The modules may be provided as standalone modules as illustrated. In addition or alternatively, the modules may be implemented as components of an application programming interface (API) that is exposed by the charging discovery service 138 to facilitate client interaction with a database of charging stations locations and recommendations related to the charging stations. The API is configured to at least handle collection of data regarding charging stations from various sources, analyze the data to generate and maintain the database of charging stations locations, handle requests from devices to access the data and/or get recommendations, and communicate data, recommendations, and/or other replies back to the devices in response to the requests.

In particular, the data collection module 202 is operable to obtain feedback 208 from computing devices 102. The feedback 208 can include information regarding device conditions as well as crowd-sourced information regarding charging stations (e.g., features, characteristics, and capabilities as well as ratings, reviews, and comments) that is supplied by a community of users, example of which were previously discussed. Optionally, the data collection module 202 may also be configured to allow charging stations 140 to register with the service. In this approach, charging stations 140 interact with the charging discovery service 138 to provide registrations 210 that are collected via the data collection module 202. Registrations 210 may indicate locations of charging stations along with corresponding details on the features, characteristics, and capabilities of the charging stations that are provided directly from providers of the charging stations.

The feedback 208 and/or registrations 210 are employed to create a database 212 that maintains information regarding charging stations and exposes the information for use by client devices. As represented in FIG. 2, the database 212 stores various data related to charging stations including but not limited to account data 214 for users and/or charging stations; device data 216 that represents device conditions that may be supplied by and stored for individual devices (e.g., device specific data), and charging station data 218 that represents location and detail records for charging stations collected and maintained by the charging service 138.

For example, the analytics module 204 is operable to produce database records based on analysis of raw data obtained from computing devices 102 and/or charging stations 140. To do so, the analytics module 204 may correlate data regarding different charging stations to generate and update a list of charging stations locations. The list of locations may be associated with additional detail information as noted above and below. The analytics module 204 may recognize input related to newly encountered (or registered) charging stations and add corresponding new records to the database. The analytics module 204 also may recognize data relating to the existing charging stations and combine the data into an existing record to avoid duplicates.

The analytics module 204 is further operable to perform analysis for identification of charging opportunities for computing devices. For example, the analytics module 204 may handle feedback 208 in the form of requests for access to the information regarding the availability of charging stations. As noted the feedback 208 provided by a device may specify a device location and conditions that may be employed to find charging stations that are suitable for charging of a battery system of the device. The device location may be determined in various ways, such as via determination of a geographic location through GPS or base station identifiers of a network connection, proximity to network beacons, a relative location derived based on device-to-device communications or other suitable mechanism to resolve location/proximity of a device. Data that is generated and supplied in response to requests is also individualized according to the device conditions. By way of example, data regarding the availability of charging stations may be filtered based on device locations, battery types, and preferences for such things as charge rates, pay or free charging, energy source type, and other factors.

Device conditions may include indications regarding a current location of the device as well as information regarding behavior and movement patterns; user preferences; scheduling information from a calendar or personal information management application; device and application usage patterns; load conditions; battery system details including number and types of batteries, charge levels, and capabilities; charging set-up details and constraints, and other factors that influence availability of charging stations. Some or all of the device conditions may be collected and/or communicated via operation of a client discovery module 130 as discussed herein. Additionally, user behaviors, patterns, and preferences can be determined and refined by observing actions of the user over time. This may include observing whether/how quickly the user reacts to a recommendation, habits regarding chargers/cables the user carries with them, device charging priority assigned by the user, acceptance or rejection of particular types of charging stations, locations, sources and terms, and so forth. Thus, the way in which a user reacts to a recommendation can be used to inform analysis for future recommendations and provide refined recommendations that are more likely to satisfy the user.

Feedback 208 can also include user or account specific details regarding the devices utilized in connection with a particular account and the capabilities of those devices. In other words, account-specific device data may be conveyed to the discovery service 138 regarding a collection of different devices that are associated with a particular account and user(s) of the account. The account-specific device data may be stored as part of account data 214. This account-specific device data generally indicates the types of devices and cables, availability or those devices and cables, and capabilities of devices with respect to supporting charging and power exchange between devices. By way of example and not limitation, data for each device associated with an account may include a list of all sockets (e.g., ports) capable of receiving and/or transmitting power for device charging; characteristics of the sockets such as charging rate available, physical socket dimensions, compatibilities with cables/chargers/other devices, charging efficiency; and a configurable priority level assigned to reflect preferences for keeping different devices charged and enable decisions based on priorities assigned to different devices. Configurable priority level can be specified explicitly be the user and/or can be inferred based on behaviors and patterns such as whether the device is regularly charged to a relatively high level (e.g., above 30% or 50%), or is allowed to run down below a threshold charge level (e.g., 5% or 10%).

Account-specific device data can further include information regarding cables, chargers, supplemental batteries, and other components associated with the account that enable different charging scenarios. Account-specific device data may further reflect a likelihood that such components are available (e.g., whether or not the user is likely to possess and/or be carrying the component), which can be based on user input, past usage, and/or detection of the components based on interconnections of the devices through wireless and wired connections. Again, this data can specify details of the components such as the number and type of sockets, charging rates, compatibility info, and so forth.

Analytics module 204 can also predict some anticipated future conditions based on feedback 208 that is supplied. For example, current location along with behavior and movement patterns can be used to make predictions regarding likely future locations of a device and user. Scheduling information provides another indication of potential future locations. In another example, usage patterns and behavior data may be used to predict an amount of time before charging is required, time slots available for charging, expected future load conditions, and other conditions.

Thus, the analytics module 204 is designed to process, refine, categorize and/or otherwise organize feedback 208 and registrations 210 to create records for the database 212. Additionally, analytics module 204 provides functionality to facilitate client discovery of charging by generating individualized data indicating charging stations that are suitable for charging of different devices, under different conditions, and in different scenarios. The individualized data generated by the analytics module 204 is then supplied to clients in various ways. For example, data can be supplied in a raw format for further processing by the clients. In addition or alternatively, data can be used to form recommendations 220 via a recommendation module 206.

The recommendation module 206 represents functionality operable to form recommendations 220 based upon data regarding charging stations supplied via the charging discovery service 204. In one example, analytics module 204 generates data based on requests as discussed above and invokes the recommendation module 206 to produce corresponding recommendations. Recommendations 220 may be configured in any suitable way. Generally, the recommendations 220 are configured to provide one or more options for charging along with details of identified charging stations, such as distance away, charging hardware available, cost structure for charging, power source details, and so forth. In one approach, a recommendation 220 can be configured to specify at least an option for charging “now” during a current time period and an option for charging “later” during a subsequent time period if a user wishes to delay charging. Recommendations 220 may include visualizations such as a map to show locations of charging stations relative to the device and/or a sorted/filtered list with visual emphasis placed on different types of stations and/or options (e.g., colors, highlighting, animations, groups, and so forth). Recommendations can include details regarding charging stations, such as the number and type of sockets, compatibility with the users' devices, cable requirements and so forth.

Recommendations, can also be based upon and include details regarding charging options available from the user's own device as well as the community of users (e.g., sharing between users). For example, upon recognition that a user has a backup USB battery pack, the service can incorporate the USB battery pack into the analysis of when and where a user is able to charge devices. In this way, exchange of power between different devices may also be considered as part of recommendations. For instance, if a laptop is capable of charging a user's phone or wireless speaker, but just one at a time, a recommendation may provide an option for charging the mobile phone now and waiting to charge the speaker, and another option indicating a charging station at which the mobile phone and speaker can be charge simultaneously. Additionally, if users opt-in to power sharing with other users, the service can make recommendations for charging of one user's device by using another user's device having sufficient charge and capabilities. For instance, the service can recognize that a mobile phone for a first user has low charge and also recognize that a nearby friend or colleague has an available spare battery. In this scenario, a recommendation for sharing the spare battery can be communicated to one or both of the users. Various other sharing scenarios are also contemplated.

Options that are included in a recommendation 220 can be identified based at least in part upon an assessment of the convenience of charging. For instance, given a particular set of constraints including the device conditions noted above, recommendation module 206 can assign convenience scores to different available charging stations and create a ranked list of options based on the scores. One or multiple options can be selected for inclusion in a recommendation 220 based on the convenience scores. The assessment of convenience accounts for factors including but not limited to preference settings, remaining charge levels, costs, time available for charging, expected time to charge; and distance between the device and charging stations, as well as expected future activities, loads, and locations derived from behavior and movement patterns. For example, charging within a current building can be considered more convenient than having to go across the street to a public charging station. Likewise fast charging may be preferred and therefore considered more convenient than slower charging. On the other hand, paid charging may be considered less convenient than a free station. The convenience assessment and assigned convenience scores reflect these and other differences between different charging stations.

Although represented as being components of the charging discovery service, some or all of the functionality represented by the analytics module 204 and recommendation module 206 may alternatively be implemented by computing devices 102 using a client discovery module 130, or otherwise. In this approach, analysis and processing to form recommendations 220 may be conducted on the client-side based upon data regarding charging stations that is supplied by the charging discovery service 138 and downloaded to individual devices. For example, charging discovery service 138 may maintain a downloadable list of charging stations and corresponding details that client devices store locally and periodically update to facilitate creation of recommendations by the client devices. Further details regarding these and other aspects of techniques for a device charging discovery service are discussed in relation to the following example procedures.

Example Procedures

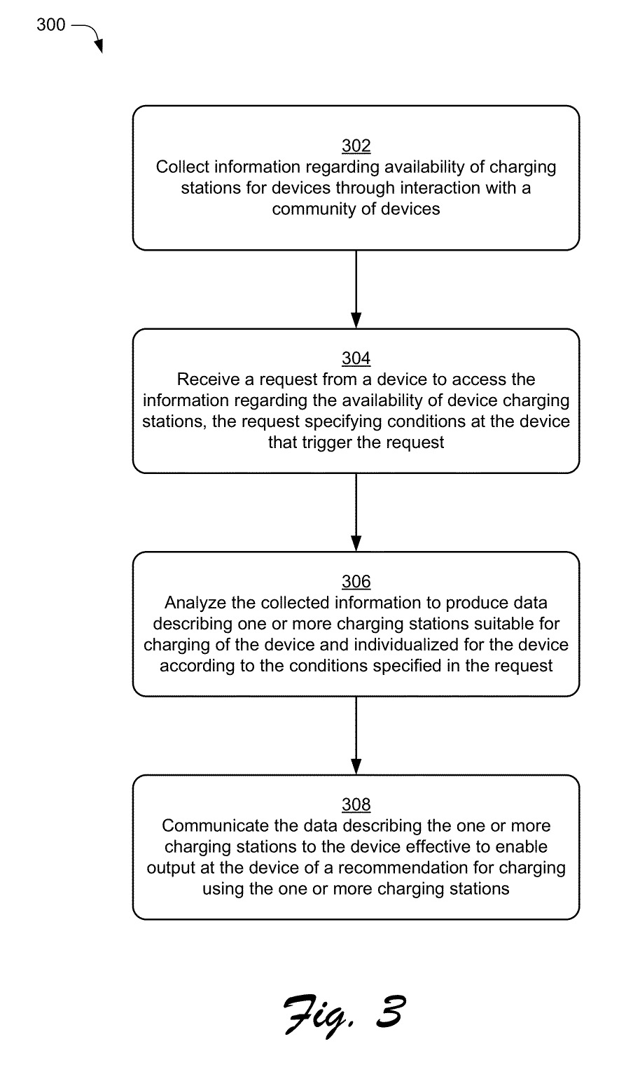

Further aspects of device charging discovery techniques are discussed in relation to example procedure of FIGS. 3 to 5. The procedures described in this document may be implemented utilizing the environment, system, devices, and components described herein and in connection with any suitable hardware, software, firmware, or combination thereof. The procedures may be represented as a set of blocks that specify operations performed by one or more entities and are not necessarily limited to the orders shown for performing the operations by the respective blocks.

FIG. 3 is a flow diagram that describes details of an example procedure 300 to provide individualized recommendations to devices regarding charging opportunities in accordance with one or more implementations. In one or more implementations, the procedure is performed via one or more devices, such as one or more server devices of a service provider 134 configured to expose a charging discovery service 138.

Information is collected regarding availability of charging stations for devices through interaction with a community of devices (block 302). For example, a charging discovery service 138 as discussed in relation to FIGS. 1 and 2 is operable to interact with devices to collect data regarding charging stations in various ways. For example, information can be extracted from feedback 208 that is communicated from the community of devices via a client discovery module 130 or otherwise. The feedback 208 includes “crowd-sourced” data that is gathered by the community of devices. The data indicates at least locations of the charging stations encountered by the community of devices and may also include detailed information, such as power source types, usage statistics, charging capabilities, and other details examples of which have been described in this document.

Information collected regarding availability of charging stations is used to establish a database to facilitate discovery of charging stations by clients. In addition to including data supplied by devices when they encountered charging stations, at least some of the data is based on registrations 210 by entities that provide the charging stations (e.g., owner/operator/individuals). Since the database relies upon crowd-sourced data, the cost and complexity of maintain the database can be reduced in comparison with a system that requires a service provider to collect data for charging sources and curate the database on their own.

A request is received from a device to access the information regarding the availability of device charging stations, the request specifying conditions at the device that trigger the request (block 304). Then, the collected information is analyzed to produce data describing one or more charging stations suitable for charging of the device and individualized for the device according to the conditions specified in the request (block 306). The data describing the one or more charging stations is communicated to the device effective to enable output at the device of a recommendation for charging using the one or more charging stations (block 308).

For instance, the charging discovery service 138, by way of an analytics module 204 or otherwise, is configured to handle requests from clients to access information kept in the database. In one or more implementations, the charging discovery service 138 exposes an application programming interface (API) accessible over a network to facilitate discovery of charging stations. The API is configured to enable the interaction with the community of devices through exchange of various messages and communications. In particular, the API is operable to collect the information from devices, obtain requests form the devices, and cause operations to produce and supply data describing one or more charging stations in response to the requests.

Requests obtained via the API and processed by the discovery service 138 may indicate at least a current location, which the service uses to retrieve records for charging stations that are within a designated proximity of the current location. The designated proximity sets a configurable distance for assessing charging station availability, such as within a mile or a number of blocks of the current location. Thus, one or more charging stations may be selected based in part upon locations of the charging stations relative to a current location of the device.

Requests can also specify other device conditions that can be used to further individualize data supplied in response to the requests. In one or more implementations, conditions specified in a request can include, but are not limited one or more of the current device location, charge levels of one or more batteries associated with the device, battery types, anticipated device usage, and predicted future locations. These and other device conditions are utilized to discover charging stations that are suitable for charging a device given the particular context that is expressed by the device conditions. Further, one or more charging stations can be selected based in part upon an assessment of convenience of charging as discussed previously. The assessment of convenience accounts for various factors indicative of convenience including but not limited to preference settings, time available for charging; expected time to charge, distance between the device and charging stations, and expected future activities, loads, and locations derived from behavior and movement patterns. Accordingly, generation of data describing the one or more charging stations suitable for a device can be based on an assessment of one or more of current device conditions, predicted future conditions, and convenience of charging.

As noted previously, data generated in response to request can be used to form recommendations 220 via a recommendation module 206. The recommendation module 206 can be implemented as a component of the charging discovery service 138. In this case, communication of data describing the one or more charging stations involves using the data describing the one or more charging stations to form a recommendation. The recommendation is configured to specify at least one opportunity for charging via charging stations indicated by the generated data and to indicate charging stations locations in relation to current and/or predicted locations for the device. The recommendation can also be configured as a detailed recommendation that includes detailed information for the one or more charging stations including at least the locations, power source types, usage statistics (e.g., number of plug-ins, % utilized, waiting time, etc.), and charging capabilities. A variety of other kind of information can also be included in a recommendation, such as rating and comments from users, pay structure indications, distinctions as public/private, indication of other amenities associated with stations (e.g., waiting area, food availability, entertainment), and/or to name a few examples. Once it is configured by the service, the recommendation is sent for output at the device.

Alternatively, the recommendation module 206 can be implemented as a component of a client discovery module 130. In this example, communication of data describing the one or more charging stations involves supplying at least information identifying locations of the one or more charging stations to the device for processing by the recommendation module 206. For example a list of stations that are proximate to current and/or predicted locations can be sent to a computing device to facilitate creation of recommendations at the device. The recommendation module 206 at the device is configured to generate the recommendations based on the locations that are supplied by the client discovery module 130. Of course, additional detail information for the charging stations can also be included along with the locations and can be utilized by the recommendation module 206 to further individualize recommendations based on various criteria.

It is noted, that charging techniques discussed above and below can also be extended to cover accessory devices associated with a computing device that have chargeable batteries, such as a wearable device, wireless headphones, an input device or keyboard, and so forth. In one approach, a first device such as a mobile phone operates to perform discovery of charging stations on behalf of associated devices. For example, the associated devices interact with the first device to report battery charge levels, battery types, charging requirements, and so forth. The first device identifies when to make discovery requests for its own battery system and/or for respective batteries of the associated devices, and communicates appropriate requests in the manner discussed herein. When multiple device having respective batteries are associated with one another, a discovery request can be configured to seek information regarding charging stations suitable to charge the multiple devices so a user is able to recharge both the multiple devices at the same place and/or at the same time. In this case, analysis of collected information in response to a request includes identifying charging stations as being suitable for charging batteries of one or more related devices indicated in the request. In this manner, a recommendation for charging of a computing device can be based on a request that is submitted on behalf the computing device by another associated device associated. For example, the two devices may be related by virtue of being owned or possessed by the same user and/or by being used in connection with the same account and user credentials.

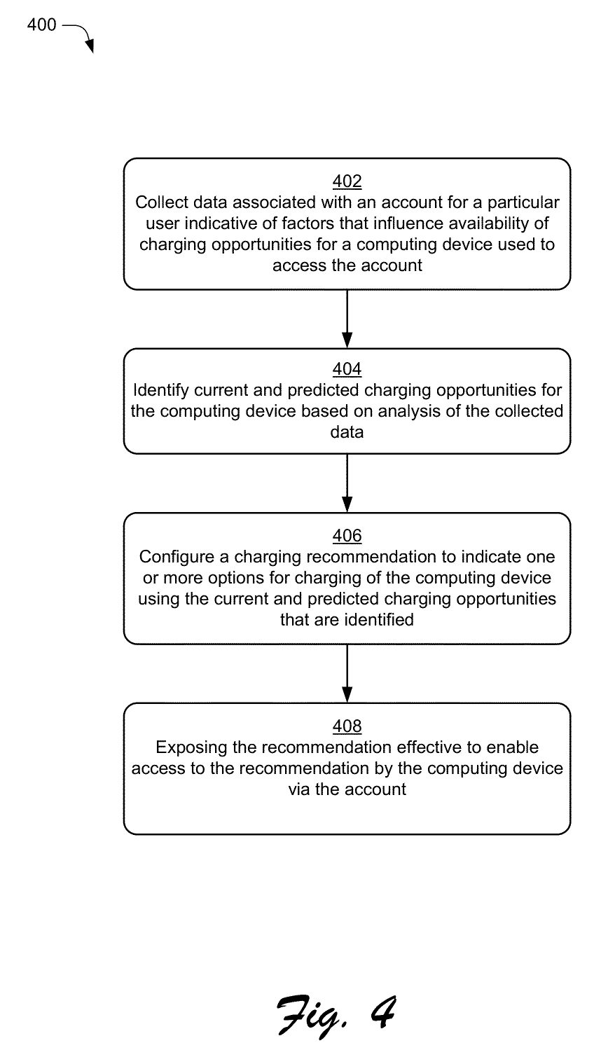

FIG. 4 is a flow diagram that describes details of an example procedure 400 for communication of charging recommendations that account for future charging opportunities to devices in accordance with one or more implementations. In one or more implementations, the procedure is performed via one or more devices, such as one or more server devices of a service provider 134 configured to expose a charging discovery service 138.

Data associated with an account for a particular user is collected that is indicative of factors that influence availability of charging opportunities for a computing device used to access the account (block 402). Various factors that influence availability of charging opportunities are contemplated. The factors can include but are not limited to various kinds of device conditions discussed herein. In one or more implementations, the factors include device and/or user specific information such as one or more of device/user behaviors, preferences, load conditions, historic activity and travel/movement patterns, and predictions for future locations, usage, loads, travel routes, and so forth. Data can be collected through interaction with client computing devices to obtain feedback 208, such as using a data collection module 202 or comparable functionality.

Current and predicted charging opportunities are identified for the computing device based on analysis of the collected data (block 404). For example, an analytics module 204 may be invoked to assess charging opportunities in dependence upon factors indicated in feedback 208 provided by a device. For example, the analytics module 204 can ascertain charging stations located near to a current device location that also meet other criteria, such as preferences for power source type, payment structure, and distance from the current location.

Additionally, the analytics module 204 can predicted future locations based on behavior and movement patterns and ascertain charging stations that correspond to the future locations. For instance, the analytics module 204 may recognize a travel route frequently taken by a user and ascertain charging stations located along the route. In another example, the analytics module 204 can parse scheduling information to look for locations at which a user has appointments and identify charging stations proximate to the appointment locations and/or along routes to get to the appointments. The analytics module 204 can also predict future load conditions to determine when charging is likely to be needed and identify charging opportunities accordingly. A variety of other examples of using future predictions of device condition for charging opportunity assessments are also contemplated.

A charging recommendation is configured to indicate one or more options for charging of the computing device using the current and predicted charging opportunities that are identified (block 406). For instance, a recommendation module 206 may be invoked to generate recommendations as described herein based on charging opportunity assessments that are made by the analytics module 204. A charging recommendation can be derived based in part upon a location of the device and include indications regarding locations of charging stations relative of the location of the device. Moreover,

The analytics module 204 can identify both opportunities to charge “now” and opportunities to charge “later”. As such, options for charging included in a recommendation can include at least an option for charging during a current time period (e.g., now) and an option for charging during a future time period (e.g., later). Then, the recommendation is exposed effective to enable access to the recommendation by the computing device via the account (block 408). A recommendation may be exposed in various ways. In one example, exposing the recommendation involves communicating the recommendation as a message for receipt and output by the computing device. Alternatively, exposing the recommendation may involve associating the recommendation with the account, storing the recommendation at a network accessible storage location, and providing access to the recommendation via the account. In this way, a user can access the recommendation from a service provider over a network, such as by navigation of a browser or other web-enabled application to retrieve, view and interact with the recommendation.

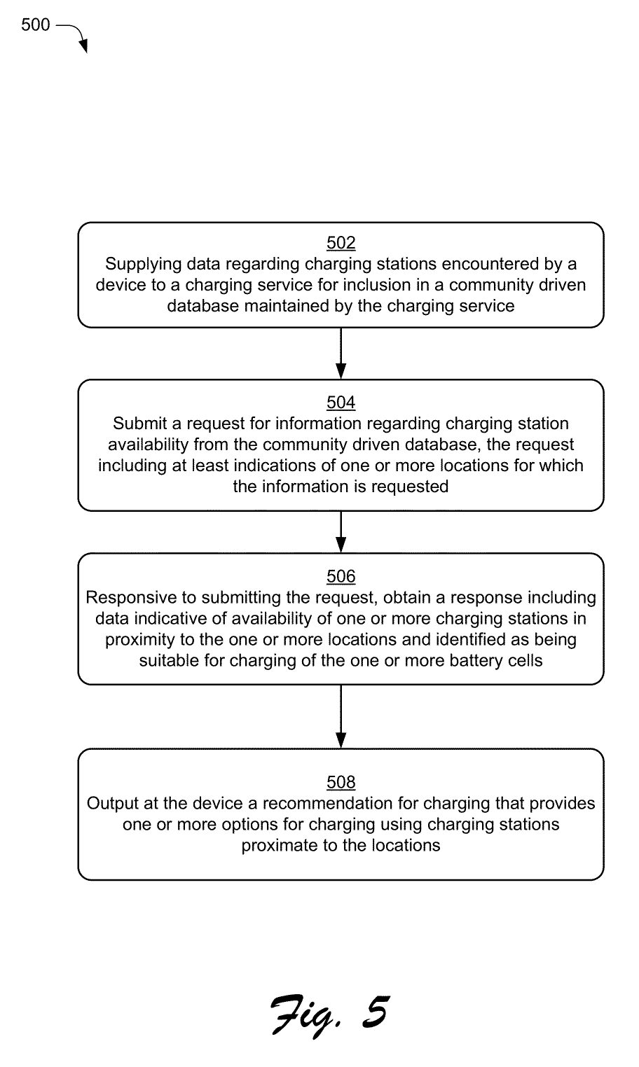

FIG. 5 is a flow diagram that describes details of an example procedure 500 to perform operations for discovery of opportunities for charging in accordance with one or more implementations. In one or more implementations, the procedure is performed via a suitably configured computing device, such as a computing device 102 that includes a client discovery module 130 as described herein.

Data regarding charging stations encountered by a device is supplied to a charging service for inclusion in a community driven database maintained by the charging service (block 502). For example, a client discovery module 130 may be configured to collect data regarding charging stations in various ways. Collected data may be employed to establish a database 212 of charging stations that is maintained at least partially using crowd-sourced information from a community of users and corresponding devices. In one or more implementations, the client discovery module 130 is configured to automatically and without user intervention collect at least some information regarding charging stations when the computing device is connected for charging at the charging stations. For instance, the client discovery module 130 may automatically collect information regarding charging stations locations and capabilities such as charge rate, type of connections/plugs (e.g., wall socket, USB, Qi pads, etc.), and charging context derived from network connection identifiers such as WIFI SSID, Cell Tower ID, connection names, and the like.

In addition or alternatively, some user specified information regarding charging stations can be obtained via a dialog exposed via the client discovery module 130 to collect supplemental data regarding the charging stations. The dialog may request input of items that may be difficult to obtain automatically, such as number of ports for charging, amenities in the vicinity, a business name, payment terms, and so forth. Additionally, the dialog can be used to enable users to input feedback on their experience with the charging station, such as ratings and comments input via the dialog. Accordingly, the collected data can include either or both of automatically collected data and user specified information.

A request is submitted for information regarding charging station availability from the community driven database, the request including at least indications of one or more locations for which the information is requested (block 504). For example, a discovery request can be submitted via the client discovery module 130 in response to various trigger events. By way of example and not limitation, trigger events can include detection of low power, an indication of low charge for an accessory device, user interaction to trigger a request, identification of future load conditions, recognition of travel plans or meetings that may limit charging opportunities, and so forth. Requests may provide various combination of device conditions as discussed herein. This includes indications of one or more locations for which information is requested.

Responsive to submitting the request, a response is obtained that includes data indicative of availability of one or more charging stations in proximity to the one or more locations and identified as being suitable for charging of the one or more battery cells (block 506). As described herein, locations can include a current location of the computing device and/or predicted future locations that are derived from one or more of schedule information or behavior and movement patterns associated with the computing device. Accordingly, the response may include indications data for charging stations that correspond to a current location and/or predicted future locations.

Then, a recommendation for charging is output at the device that provides one or more options for charging using charging stations proximate to the locations (block 508). Again, recommendations may be formed via operations performed by a charging discovery service 138 or by a client discovery module 130 at a computing device 102. In implementations in which recommendations are generated via the charging discovery service 138, the client discovery module 130 can supply device conditions and/or other information to the service to facilitate identification of suitable charging stations and creation of the recommendations. In particular, client discovery module 130 operates to monitor device conditions of the device including but not limited to behaviors, preferences, and expected device usage. Then, the client discovery module 130 submits feedback regarding the device conditions to the charging discovery service 1 in connection with requests. A recommendation is then formed by the charging discovery service 138 and individualized according to the feedback to indicate the one or more charging discovery service 138 stations as being suitable for charging of the one or more battery cells is obtained responsive to submitting the feedback.

In implementations in which recommendations are generated by the client discovery module 130, data obtained in the response is used to recognize suitable charging stations and form corresponding recommendations. In one example, the data indicative of availability of one or more charging stations is used to assess convenience of charging at the locations in the manner described herein. Then, a recommendation is formed at the computing device that is configured to provide one or more options for charging of the computing device using charging stations that are proximate to the locations based on the convenience assessment.

Having considered the foregoing details and procedures, consider now example system and components associated with one or more implementations of a charging discovery service.

Example System

FIG. 6 illustrates an example system 600 that includes an example computing device 602 that is representative of one or more computing systems and/or devices that may implement the various techniques described herein. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interfaces 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware elements 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 606 is illustrated as including memory/storage 612. The memory/storage 612 represents memory/storage capacity associated with one or more computer-readable media. The memory/storage 612 may include volatile media (such as random access memory (RAM)) and/or nonvolatile media (such as read only memory (ROM), Flash memory, optical disks, magnetic disks, and so forth). The memory/storage 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone for voice operations, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “communication media.”

“Computer-readable storage media” refers to media and/or devices that enable storage of information in contrast to mere signal transmission, carrier waves, or signals per se. Thus, computer-readable storage media does not include signal bearing media, transitory signals, or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” may refer to signal-bearing media that is configured to transmit instructions to the hardware of the computing device 602, such as via a network. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including the operating system 108, applications 110, power manager module 126, client discovery module 130, and other program modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of modules as a module that is executable by the computing device 602 as software may be achieved at least partially in hardware, e.g., through use of computer-readable storage media and/or hardware elements 610 of the processing system. The instructions and/or functions may be executable/operable by one or more articles of manufacture (for example, one or more computing devices 602 and/or processing systems 604) to implement techniques, modules, and examples described herein.

As further illustrated in FIG. 6, the example system 600 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 600, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 602 may assume a variety of different configurations, such as for computer 614, mobile 616, and television 618 uses. Each of these configurations includes devices that may have generally different constructs and capabilities, and thus the computing device 602 may be configured according to one or more of the different device classes. For instance, the computing device 602 may be implemented as the computer 614 class of a device that includes a personal computer, desktop computer, a multi-screen computer, laptop computer, netbook, and so on.

The computing device 602 may also be implemented as the mobile 616 class of device that includes mobile devices, such as a mobile phone, portable music player, portable gaming device, a tablet computer, a multi-screen computer, and so on. The computing device 602 may also be implemented as the television 618 class of device that includes devices having or connected to generally larger screens in casual viewing environments. These devices include televisions, set-top boxes, gaming consoles, and so on.

The techniques described herein may be supported by these various configurations of the computing device 602 and are not limited to the specific examples of the techniques described herein. This is illustrated through inclusion of the battery system 128 and client discovery module 130 on the computing device 602. The functionality represented by the battery system 128, client discovery module 130, and other modules/applications may also be implemented all or in part through use of a distributed system, such as over a “cloud” 620 via a platform 622 as described below.

The cloud 620 includes and/or is representative of a platform 622 for resources 624. The platform 622 abstracts underlying functionality of hardware (e.g., servers) and software resources of the cloud 620. The resources 624 may include applications and/or data that can be utilized while computer processing is executed on servers that are remote from the computing device 602. By way of example, the resources may include a charging discovery service 138 as described in this document. Resources 624 can also include services provided over the Internet and/or through a subscriber network, such as a cellular or Wi-Fi network.

The platform 622 may abstract resources and functions to connect the computing device 602 with other computing devices. The platform 622 may also serve to abstract scaling of resources to provide a corresponding level of scale to encountered demand for the resources 624 that are implemented via the platform 622. Accordingly, in an interconnected device embodiment, implementation of functionality described herein may be distributed throughout the system 600. For example, the functionality may be implemented in part on the computing device 602 as well as via the platform 622 that abstracts the functionality of the cloud 620.

### EXAMPLE IMPLEMENTATIONS

Example implementations of techniques described herein include, but are not limited to, one or any combinations of one or more of the following examples:

### Example 1

A method to provide individualized recommendations to devices regarding charging opportunities via a charging service implemented by a service provider comprising: collecting information regarding availability of charging stations through interaction with a community of devices; receiving a request from a device to access the information regarding the availability of charging stations; analyzing the collected information to produce data describing one or more charging stations suitable for charging of the device and individualized for the device according to conditions at the device; and communicating the data describing the one or more charging stations to the device effective to enable output at the device of a recommendation for charging using the one or more charging stations.

### Example 2

The method in any one or more of the examples in this section, wherein collecting the information comprises obtaining feedback communicated from the community of devices that includes data gathered by the community of devices indicating locations and details of device charging stations encountered by the community of devices.

### Example 3

The method in any one or more of the examples in this section, wherein communicating the data describing the one or more charging stations comprises using the data describing the one or more charging stations to form the recommendation and sending the recommendation for output at the device, the recommendation configured to specify at least one opportunity for charging via the one or more charging stations.

### Example 4

The method in any one or more of the examples in this section, wherein communicating the data describing the one or more charging stations comprises supplying at least information identifying locations of the one or more charging stations to the device, the device configured to generate the recommendation based on the locations that are supplied.

### Example 5

The method in any one or more of the examples in this section, wherein the conditions include one or more of a current device location, charge levels of one or more batteries associated with the device, battery types, anticipated device usage, and predicted future locations.

### Example 6

The method in any one or more of the examples in this section 1, wherein analyzing the collected information comprises selecting the one or more charging stations based in part upon locations of the charging stations relative to a current location of the device.

### Example 7

The method in any one or more of the examples in this section, wherein analyzing the collected information further comprises selecting the one or more charging stations based in part upon an assessment of convenience of charging that accounts for at least preference settings, time available for charging, expected time to charge, distance between the device and charging stations, and expected future activities, loads, and locations derived from behavior and movement patterns.

### Example 8

The method in any one or more of the examples in this section, wherein the device is associated with one or more associated devices having respective batteries and analyzing the collected information includes identifying the one or more charging stations as being suitable for charging of the batteries for associated devices indicated in the request.

### Example 9

The method in any one or more of the examples in this section 1, further comprising exposing by the charging service an application programming interface (API) accessible over a network to enable the interaction with the community of devices and operable to collect the information from devices, obtain the request, and cause operations to produce and supply the data describing the one or more charging stations in response to the request.

### Example 10

The method in any one or more of the examples in this section, wherein the recommendation is configured to include detailed information for the one or more charging stations including at least locations, power source types, usage statistics, information regarding available sockets and charging capabilities.

### Example 11

A system comprising: one or more server computing devices associated with a service provider; a charging service implemented via the one or more server devices to perform operations for communication of charging recommendations that account for future charging opportunities to devices, the operations including: collecting data associated with an account for a particular user indicative of factors that influence availability of charging opportunities for at least one computing device used to access the account; identifying based on analysis of the collected data current and predicted charging opportunities for the computing device; configuring a charging recommendation to indicate one or more options for charging of the computing device using the current and predicted charging opportunities that are identified; and exposing the recommendation effective to enable access to the recommendation by the computing device via the account.

### Example 12

The computing device in any one or more of the examples in this section, wherein the options for charging include at least an option for charging during a current period time interval and an option for charging during a future time period.

### Example 13

The computing device in any one or more of the examples in this section, wherein the charging recommendation is derived based in part upon a location of the computing device and includes indications regarding locations of charging stations relative of the location of the device.

### Example 14

The computing device in any one or more of the examples in this section, wherein the charging recommendation includes a recommendation for charging of the computing device based on a request submitted on behalf the computing device by another device associated with the account.

### Example 15

The computing device in any one or more of the examples in this section, wherein the charging recommendation is configured to include an option for charging of the computing device by exchanging power with one or more associated devices recognized as being currently available charging of the computing device.

### Example 16

A computing device comprising: a battery system having one or more battery cells; one or more computer readable media storing instructions that, when executed via the computing device, implement a power discovery module configured to interact with a charging service for discovery of opportunities for charging of the one or more battery cells, the operations including: supplying data regarding charging stations encountered by the computing device to the charging service for inclusion in a community driven database maintained by the charging service; submitting a request for information regarding charging station availability from the community driven database, the request including at least indications of one or more locations for which the information is requested; responsive to submitting the request, obtaining a response including data indicative of availability of one or more charging stations in proximity to the one or more locations and identified as being suitable for charging of the one or more battery cells.

### Example 17

A computing device as in any one or more of the examples in this section, further comprising: monitoring device conditions of the device including behaviors, preferences, and expected device usage; submitting feedback regarding the device conditions to the charging service in connection with the request; and responsive to submitting the feedback, obtaining as the response a recommendation formed by the charging service and individualized according to the feedback to indicate the one or more charging stations as being suitable for charging of the one or more battery cells.

### Example 18

A computing device as in any one or more of the examples in this section, further comprising: using the data indicative of availability of one or more charging stations to assess convenience of charging at the locations; forming at the computing device a recommendation configured to provide one or more options for charging of the computing device using charging stations proximate to the locations based on the convenience assessment.

### Example 19

A computing device as in any one or more of the examples in this section, wherein the locations include a current location of the computing device and at least one predicted future location that is derived from one or more of schedule information or behavior and movement patterns associated with the computing device;

### Example 20

A computing device as in any one or more of the examples in this section, wherein the data that is supplied regarding charging stations encountered by the computing device includes at least one of: data regarding charging station locations and capabilities collected automatically and without user intervention when the computing device is connected for charging at the charging stations charging stations; or user specified information regarding charging stations obtained via a dialog exposed to collect supplemental data regarding the charging stations including ratings and comments input by users.

### CONCLUSION

Although techniques and aspects have been described in language specific to structural features and/or methodological acts, it is to be understood that the subject matter defined in the appended claims are not necessarily limited to the specific features or acts described. Rather, the specific features and acts are disclosed as example forms of implementing the claimed subject matter.

What is claimed is:

1. A method to provide individualized recommendations to devices regarding charging opportunities via a charging service implemented by a service provider comprising:
collecting information regarding availability of charging stations through interaction with a community of devices;
receiving a request from a device to access the information regarding the availability of charging stations;
analyzing the collected information to produce data describing one or more charging stations suitable for charging of the device and individualized for the device according to conditions at the device; and
communicating the data describing the one or more charging stations to the device effective to enable output at the device of a recommendation for charging using the one or more charging stations.

2. The method of claim 1, wherein collecting the information comprises obtaining feedback communicated from the community of devices that includes data gathered by the community of devices indicating locations and details of device charging stations encountered by the community of devices.

3. The method of claim 1, wherein communicating the data describing the one or more charging stations comprises using the data describing the one or more charging stations to form the recommendation and sending the recommendation for output at the device, the recommendation configured to specify at least one opportunity for charging via the one or more charging stations.

4. The method of claim 1, wherein communicating the data describing the one or more charging stations comprises supplying at least information identifying locations of the one or more charging stations to the device, the device configured to generate the recommendation based on the locations that are supplied.

5. The method of claim 1, wherein the conditions include one or more of a current device location, charge levels of one or more batteries associated with the device, battery types, anticipated device usage, and predicted future locations.

6. The method of claim 1, wherein analyzing the collected information comprises selecting the one or more charging stations based in part upon locations of the charging stations relative to a current location of the device.

7. The method of claim 6, wherein analyzing the collected information further comprises selecting the one or more charging stations based in part upon an assessment of convenience of charging that accounts for at least preference settings, time available for charging, expected time to charge, distance between the device and charging stations, and expected future activities, loads, and locations derived from behavior and movement patterns.

8. The method of claim 1, wherein the device is associated with one or more associated devices having respective batteries and analyzing the collected information includes identifying the one or more charging stations as being suitable for charging of the batteries for associated devices indicated in the request.

9. The method of claim 1, further comprising exposing by the charging service an application programming interface (API) accessible over a network to enable the interaction with the community of devices and operable to collect the information from devices, obtain the request, and cause operations to produce and supply the data describing the one or more charging stations in response to the request.

10. The method of claim 1, wherein the recommendation is configured to include detailed information for the one or more charging stations including at least locations, power source types, usage statistics, information regarding available sockets and charging capabilities.

11. A system comprising:
one or more server computing devices associated with a service provider;
a charging service implemented via the one or more server devices to perform operations for communication of charging recommendations that account for future charging opportunities to devices, the operations including:
collecting data associated with an account for a particular user indicative of factors that influence availability of charging opportunities for at least one computing device used to access the account;
identifying based on analysis of the collected data current and predicted charging opportunities for the computing device;
configuring a charging recommendation to indicate one or more options for charging of the computing device using the current and predicted charging opportunities that are identified; and
exposing the recommendation effective to enable access to the recommendation by the computing device via the account.

12. The computing device of claim 11, wherein the options for charging include at least an option for charging during a current period time interval and an option for charging during a future time period.

13. The computing device of claim 11, wherein the charging recommendation is derived based in part upon a location of the computing device and includes indications regarding locations of charging stations relative of the location of the device.

14. The computing device of claim 11, wherein the charging recommendation includes a recommendation for charging of the computing device based on a request submitted on behalf the computing device by another device associated with the account.

15. The computing device of claim 11, wherein the charging recommendation is configured to include an option for charging of the computing device by exchanging power with one or more associated devices recognized as being currently available for charging of the computing device.

16. A computing device comprising:
a battery system having one or more battery cells;
one or more computer readable media storing instructions that, when executed via the computing device, implement a power discovery module configured to interact with a charging service for discovery of opportunities for charging of the one or more battery cells, the operations including:
supplying data regarding charging stations encountered by the computing device to the charging service for inclusion in a community driven database maintained by the charging service;
submitting a request for information regarding charging station availability from the community driven database, the request including at least indications of one or more locations for which the information is requested;
responsive to submitting the request, obtaining a response including data indicative of availability of one or more charging stations in proximity to the one or more locations and identified as being suitable for charging of the one or more battery cells.

17. A computing device as recited in claim 16, further comprising:
monitoring device conditions of the device including behaviors, preferences, and expected device usage;
submitting feedback regarding the device conditions to the charging service in connection with the request; and
responsive to submitting the feedback, obtaining as the response a recommendation formed by the charging service and individualized according to the feedback to indicate the one or more charging stations as being suitable for charging of the one or more battery cells.

18. A computing device as recited in claim 16, further comprising:
using the data indicative of availability of one or more charging stations to assess convenience of charging at the locations;
forming at the computing device a recommendation configured to provide one or more options for charging of the computing device using charging stations proximate to the locations based on the convenience assessment.

19. A computing device as recited in claim 16, wherein the locations include a current location of the computing device and at least one predicted future location that is derived from one or more of schedule information or behavior and movement patterns associated with the computing device;

20. A computing device as recited in claim 16, wherein the data that is supplied regarding charging stations encountered by the computing device includes at least one of:
data regarding charging station locations and capabilities collected automatically and without user intervention when the computing device is connected for charging at the charging stations charging stations; or
user specified information regarding charging stations obtained via a dialog exposed to collect supplemental data regarding the charging stations including ratings and comments input by users.
